(19) United States
(12) Patent Application Publication
(10) Pub. No.: US 2003/0146873 A1
(43) Pub. Date: Aug. 7, 2003

(54) Planar radiating surface antenna and portable telephone comprising same

(76) Inventor: Francois Blancho, Herblay (FR)

Correspondence Address: Bakely Sokoloff, Taylor & Zafman, 7th Floor, 12400 Wilshire Boulevard, Los Angeles, CA, 90025, US

(21) Appl. No.: 10/343,530

(22) PCT Filed: Jul. 31, 2001
(86) PCT No.: PCT/FR01/02498

(30) Foreign Application Priority Data
Aug. 1, 2000 (FR) 00/10126

(51) Int. Cl. H01Q 1/24; H04M 1/00; H04B 1/38

(52) U.S. Cl. 343/700 MS; 455/550; 343/702

(57) ABSTRACT

The invention concerns a transmission/reception antenna comprising a ground plane and at least a planar radiating surface extending plumb over said ground plane and parallel thereto. The invention is characterised in that the radiation section(s) are linked to means defining at least an adaptation circuit which, in transmission as well as in reception is resonant on simultaneously at least two frequency bands.

### GENERAL FIELD OF THE INVENTION AND STATE OF THE ART

The present invention relates to an antenna of the type having planar radiating surface(s).

The invention proposes in particular an antenna of this type able to be used in transmission/reception on at least two frequency bands.

It also proposes a portable telephone structure comprising such an antenna.

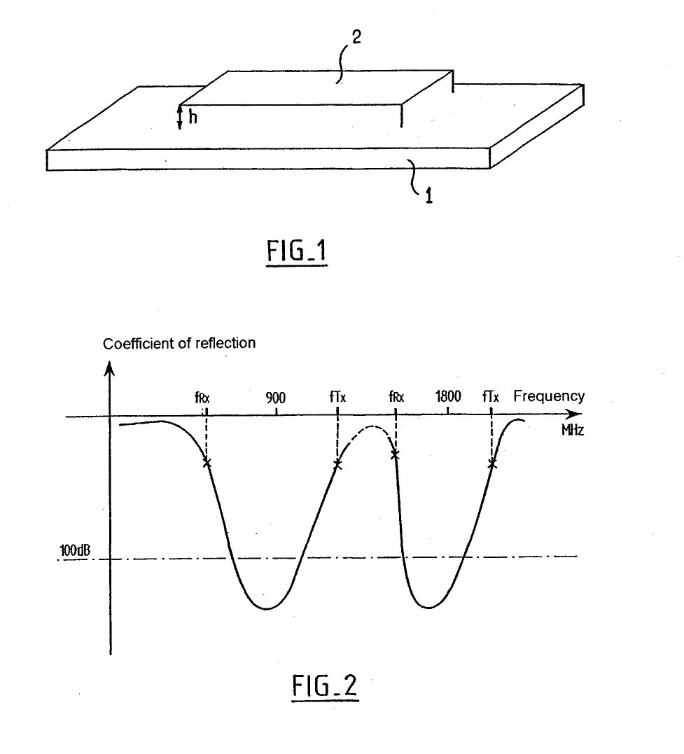

The use, for portable telephones, of so-called PIFA (Planar Inverted-F Antenna) planar antennas has already been proposed, the latter comprising, as illustrated in FIG. 1, a ground plane 1 and a planar conducting surface 2 which is overlaid on this ground plane 1 and extends plumb and parallel thereto. Such an arrangement has a resonance wavelength which is dependent on the dimensions of the planar conducting surface 2 and on the height which separates it from its ground plane 1.

These antennas have an important advantage in particular in terms of bulkiness.

However, a limitation of these antennas is that the smaller the height h which separates their radiating surface 2 from their ground plane 1, the more restricted the width of their passband.

Indeed this prevents the obtaining of an optimal gain over all the channels used on one and the same passband.

In particular, portable telephones are already known which use antennas of the aforesaid type which comprise two radiating surfaces which are of different dimensions and which are disposed in one and the same plane, above one and the same ground plane.

These two radiating surfaces thus make it possible, as illustrated by the graph of FIG. 2, to obtain two frequency bands for the antenna, one around 900 Mhz, the other around 1.8 GHz.

However, the use of “duplex” separation on transmission/reception, as is customarily the case in GSM systems, leads to the use, for the transmission and reception frequencies f_{TX}, f_{RX}, of the edges of the resonance bands of the antenna, where the matching is unsatisfactory.

### PRESENTATION OF THE INVENTION

An aim of the invention is to alleviate the aforesaid drawbacks and to propose an antenna of the aforesaid type with a gain which is optimized for various channels in one and the same resonance band of the antenna.

Another aim likewise of the invention is to propose an antenna with at least two transmission/reception bands which is of restricted bulkiness.

WO 90/13152 discloses an antenna structure which comprises two radiating elements, one which is used for transmission, the other which is used for reception. No provision is made for using a resonant circuit simultaneously on several frequency bands, the toggling onto various reception subbands being achieved by the switching of capacitive or inductive means.

It is also known, for example from EP 687 030, to modify a resonant frequency of an antenna by means of a capacitor switched by a diode.

Moreover, EP 892 459 discloses circuits making it possible to toggle from a transmission band to a reception band.

These various structures do not make it possible to achieve the aims of the invention.

For its part, the invention proposes a transmission/reception antenna comprising a ground plane and at least one planar radiation surface which extends plumb with said ground plane and parallel thereto, characterized in that the radiation section or sections are linked to means defining at least one matching circuit which, both in transmission and in reception, is simultaneously resonant on at least two frequency bands.

In particular, the means defining a matching circuit are advantageously arranged in parallel with capacitive or inductive means themselves arranged in series with means able to be switched selectively between an on state and an off state, these capacitive or inductive means shifting the resonance bands of the antenna, depending on whether the means able to be switched are in the on state or in the off state.

In a preferred embodiment, the antenna comprises at least two radiation surfaces linked by means forming at least one matching circuit.

The two radiation surfaces are advantageously in one and the same plane.

Moreover, the antenna is linked to the ground plane and to RF signals feed electronics and reception electronics by two points on either side of a radiating section.

The means forming a matching circuit are split on either side of the radiating sections.

The invention also relates to a portable telephone structure which comprises such an antenna.

In particular, it proposes a portable telephone structure comprising a casing in the bottom of which is disposed a ground plane and loudspeaker electronics, structure in which said ground plane is extended by a shield member which exhibits an indentation toward the loudspeaker and which constitutes the ground plane of an antenna of the aforesaid type whose radiating section or sections are disposed in the casing alongside the shield member away from the loudspeaker.

Other characteristics and advantages of the invention will emerge further from the description which follows, which is purely illustrative and nonlimiting and should be read in conjunction with the appended drawings in which:

FIG. 1, already discussed, diagrammatically represents an antenna of PIFA type in accordance with a known state of the art;

FIG. 2, likewise already discussed, is a matching/frequency graph illustrating the distribution of the transmission/reception frequencies with respect to the frequency bands of a twin-band PIFA-type antenna in accordance with a known state of the art;

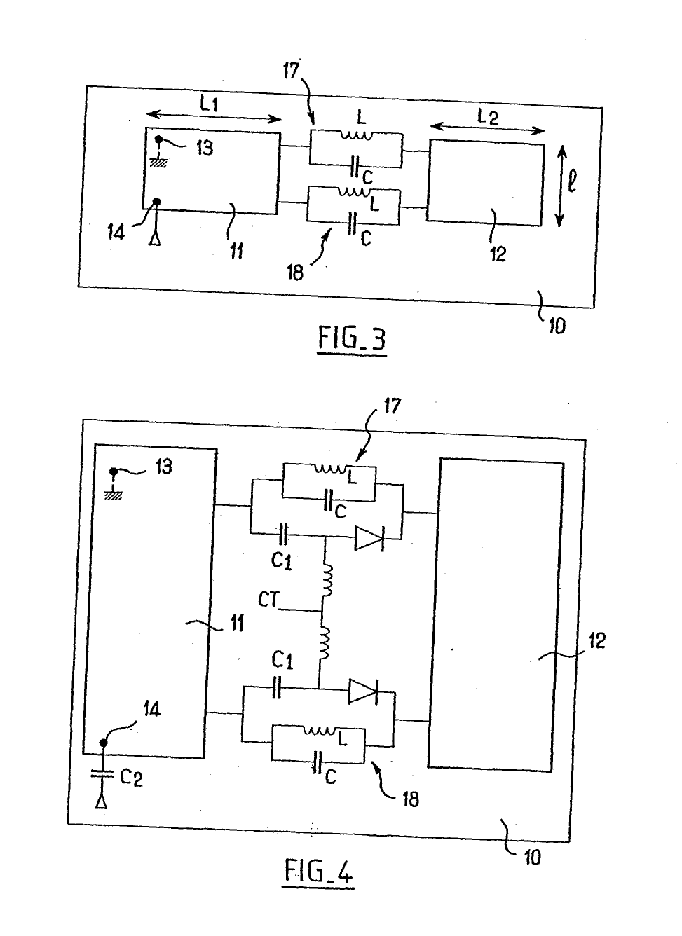

FIG. 3 is a diagrammatic representation viewed from above of an antenna in accordance with a possible embodiment of the invention;

FIG. 4 is a diagrammatic representation viewed from above of an antenna in accordance with a preferred embodiment of the invention;

FIG. 5 is a graph similar to that of FIG. 2 illustrating the operation of an antenna of the type of that of FIG. 4.

The antenna represented in FIG. 3 comprises a ground plane 10 and two planar radiating elements 11 and 12 which extend in an overlaid manner on said ground plane 10, while being parallel thereto and disposed in one and the same plane.

These two elements 11 and 12 are both of rectangular sections. They are in this instance aligned with respect to one another and exhibit one and the same width 1. Their respective lengths, referenced L1 and L2, may be equal or different.

More precisely, these two radiating sections 11 and 12 satisfy substantially the following equation:

λ₁/4>h+L₁+L₂+½>

with λₙ=c/ƒₙ.

At its end away from the radiating section 12, the radiating section 11 is linked on one side to the ground plane (linking point 13) and on the other to RF signals feed/reception electronics (linking point 14).

The two sections 11 and 12 are linked together by at least one circuit which allows the antenna to resonate on two frequency bands centered on the frequencies F1 and F2.

More precisely, provision is made for two identical LC stopper circuits on either side of the midlength of the two sections 11 and 12, which can be understood in this instance, given the layout of the points 13 and 14, as a line of symmetry for the arrangement.

The values of the components L and C of these stopper circuits are chosen in such a way that these circuits exhibit a resonant frequency substantially in the middle of F1 and F2.

In a simplified manner, the operation of an arrangement of the type of that just described can be understood in the following manner.

It is known that a stopper circuit behaves substantially as a purely inductive element before its resonant frequency and as a purely capacitive element after its resonant frequency.

The introduction of a stopper circuit between the two sections will return to supplement these with—depending on whether one is before or after said resonant frequency—a capacitor or a matching inductor. Now, the addition of an inductor to a planar antenna the same effect as if the latter were lengthened: the resonance band is displaced toward the low frequencies; the addition of a capacitor to a planar antenna, for its part, has the same effect as if the latter were shortened: the resonance band is displaced toward the high frequencies.

An arrangement of the type of that represented in FIG. 1 therefore operates with two resonance bands, which by altering the dimensions of the radiating sections and the height h, as well as the values of the components L and C, can be centered on the two resonant frequencies F1 and F2.

The antenna which is illustrated in FIG. 4 (to within differences in scales of representations) reuses all the various elements of the arrangement of FIG. 3.

It furthermore comprises, arranged in parallel with the stopper circuit 17, a branch which comprises a capacitor C1 arranged in series with an element D forming a control breaker, which in this instance is a PIN diode. A similar arrangement is arranged in parallel with the stopper circuit 18. Two diodes D of these arrangements are controlled by a voltage signal CT transmitted through the choke inductors Lc.

A protective capacitor C2 is moreover provided between the point 214 and the feed/reception electronics associated with the antenna.

Depending on whether or not a voltage signal CT is injected onto the anode of the diodes D, the latter are off or on the contrary on.

In the first case, the arrangement is equivalent to that of FIG. 3.

In the second case, the stopper circuits 17, 18 are modified by the presence of the capacitors C1 arranged in parallel with it, so that the frequencies of the two resonance bands then created are shifted with respect to those obtained when the diodes D are off.

This is illustrated by the two curves of gain which are represented in FIG. 5.

As will have been understood, the values of the various components of the arrangement just described and in particular the inductive and capacitive values are chosen in such a way that the resonant frequencies F1 and F2 correspond in one case to the “duplex” transmission frequencies f_{TX} (solid curve in FIG. 5) and in the other case to the “duplex” reception frequencies f_{RX} (dashed curve in FIG. 5).

With such an arrangement, the antenna is perfectly resonant for both of the two bands and both in transmission and in reception.

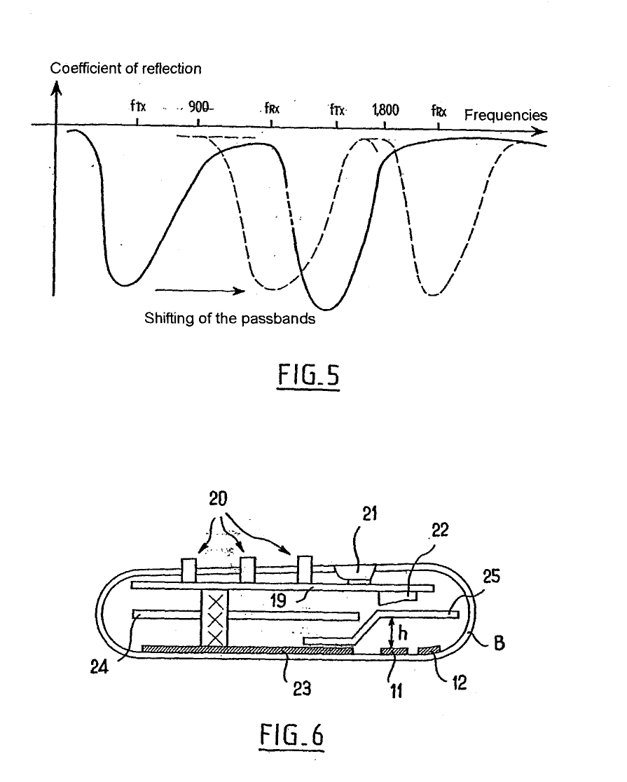

Such an antenna is advantageously integrated into a portable telephone structure, in the manner which is illustrated in FIG. 6.

This portable telephone structure comprises in a casing B a card 19 which is disposed in the vicinity of the front face of the telephone casing and which carries the various keys 20 of the keypad, means for controlling the screen 21 of the telephone, and means 22 forming a loudspeaker.

In the bottom of the casing B is disposed a metallization 23 which defines the neutral (or ground) for the portable telephone and to which the card 19 and any other cards of the telephone (card 24 in FIG. 6) are linked.

This ground plane 23 is prolonged by a metal shield 25 which extends with an indentation plumb with the means 22 forming a loudspeaker.

This metal shield 25 is used to make the ground plane of the antenna, the sections 11 and 12 of the latter being disposed on the bottom of the casing B, plumb with the shield 25.

With such a configuration, the volume occupied by the antenna arrangement is minimal, the height h between the shield 25 and the radiating sections 11 and 12 possibly being 8 mm or less.

Furthermore, an important advantage of this configuration is that the shield efficiently protects the user from the electromagnetic radiations transmitted by the antenna.

Of course, the invention has been described here in the case of dual-band transmission/reception but could be applied more generally to any transmission/reception around n frequencies.

Furthermore, the invention has been described here in the case of radiating surfaces of rectangular sections, but could of course be applied with radiating sections exhibiting other shapes.

1. A transmission/reception antenna comprising a ground plane and at least one planar radiation surface which extends plumb with said ground plane and parallel thereto, characterized in that the radiation section or sections are linked to means defining at least one matching circuit which, both in transmission and in reception, is simultaneously resonant on at least two frequency bands.

2. The antenna as claimed in claim 1, characterized in that the means defining a matching circuit are arranged in parallel with capacitive or inductive means themselves arranged in series with means able to be switched selectively between an on state and an off state, these capacitive or inductive means shifting the resonance bands of the antenna, as a function of the on or off state of the means able to be switched.

3. The antenna as claimed in one of the preceding claims, characterized in that it comprises at least two radiation surfaces linked by means forming at least one matching circuit.

4. The antenna as claimed in claim 3, characterized in that the two radiation surfaces are in one and the same plane.

5. The antenna as claimed in one of claim 3 or 4, characterized in that it is linked to the ground plane and to RF feed/reception electronics by two points on either side of a radiating section.

6. The antenna as claimed in claim 5, characterized in that the means forming a matching circuit are split on either side of the radiating sections.

7. The antenna as claimed in one of claim 5 or 6, characterized in that the RF signals feed and reception electronics are linked to the radiating section by a capacitor.

8. The antenna as claimed in claim 2 taken alone or in combination with one of claims 3 to 6, characterized in that the means able to be switched selectively between an on state and an off state comprise at least one PIN diode.

9. A portable telephone, characterized in that it comprises an antenna as claimed in one of the preceding claims.

10. A portable telephone comprising a casing in the bottom of which is disposed a ground plane and loudspeaker electronics, characterized in that said ground plane is extended by a screening member which exhibits an indentation toward the loudspeaker and which constitutes the ground plane of an antenna as claimed in one of claims 1 to 8 whose radiating section or sections are disposed in the casing alongside the shield member away from the loudspeaker.
